(19) United States
(12) Patent Application Publication
(10) Pub. No.: US 2002/0118288 A1
(43) Pub. Date: Aug. 29, 2002

(54) Image pickup device, image recording method, and image recording system

(75) Inventors: Koichiro Daigo, Tokyo (JP); Kaoru Yoshida, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd, Tokyo (JP)

(21) Appl. No.: 10/073,599

(22) Filed: Feb. 11, 2002

(30) Foreign Application Priority Data
Feb. 14, 2001 (JP) 2001-036804
Dec. 17, 2001 (JP) 2001-382970

(51) Int. Cl. H04N 5/335; H04N 3/14; H04N 7/00

(52) U.S. Cl. 348/231.3; 348/280; 348/552; 348/231.6

(57) ABSTRACT

A digital still camera easily adds information relating to a pick-up time to a picked-up image. The digital still camera is connected to Internet through communication function of a cellular phone based on a download time interval of each URL and obtains an HTML file from a URL specified by information downloaded from the Internet. When an image is picked-up and stored in a flash memory as a JPEG file, the obtained HTML file is written into a comment region of the JPEG file.

### CROSS-REFERENCE TO RELATED APPLICATIONS

This application is based upon and claims the benefit of priority from the prior Japanese Patent Applications No. 2001-036804, filed Feb. 14, 2001; and No. 2001-382970, filed Dec. 17, 2001, the entire contents of both of which are incorporated herein by reference.

### BACKGROUND OF THE INVENTION

1. Field of the Invention

The present invention relates to an image pickup device, image recording method, and image recording system.

2. Description of the Related Art

In a conventional digital still camera, when it is desired to add to a picked-up image various kinds of information about the picked-up image, the information to be added is previously stored in the digital still camera or inputted to the camera after picking-up the image.

According to the conventional technology, a digital still camera not connected to an external device such as a personal computer has such a problem that when it is desired to add information to a picked-up image, user has to prepare that information in the digital camera beforehand or input it afterward which is very much time consuming.

### BRIEF SUMMARY OF THE INVENTION

The present invention is directed to method and apparatus that substantially obviates one or more of the problems due to limitations and disadvantages of the related art.

According to a first aspect of the present invention, there is provided an image pickup device comprising: an image pickup unit which picks up image of an object; an image storage unit which stores an image picked up by the image pickup unit; a connection unit connectable to the network; an address storage unit which stores address on the network; an information obtaining unit which obtains information on the network based on an address of the address storage unit; and an adding unit which adds information obtained by the information obtaining unit to the image stored in the image storage unit.

Preferably, according to a second aspect of the invention, the image pickup device according to the first aspect, further comprises a setting unit which sets a time interval that obtains information on the network based on address in the address storage unit.

Preferably, according to a third aspect of the invention, the image pickup device according to the first aspect, further comprises the address storage unit which stores a plurality of addresses so as to obtain information from all stored addresses.

Preferably, for example, according to forth to sixth aspects of the invention, the image pickup device according to the first, second or third aspect, further comprises a browser file creating unit which describes at least picked-up image and built-in information built in the image according to a format allowing it to be browsed through a terminal accommodating a browser software.

According to a seventh aspect of the present invention, there is provided an image recording method comprising the steps of: reading an address on the network stored in the image pickup device; connecting to an address read out in the reading step through the network; obtaining information from a connecting destination connected in the connecting step through the network; and adding information obtained in the information obtaining step to the image when recording an image picked-up by the image pickup device.

Preferably, for example, according to an eighth aspect of the invention, in the image recording method according to the seventh aspect, the information obtaining step obtains information from the network based on the time interval set up preliminarily.

Preferably, for example, according to a ninth aspect of the invention, in the image recording method according to the eighth aspect, the time interval is capable of being set up for each information depending on the content of the information to be obtained.

Preferably, for example, according to tenth to twelfth aspects of the invention, the image recording method according to seventh to ninth aspects, further comprises a browser file creating step of creating a picked-up image information file in which at least picked-up image and built-in information built in the image are described according to a format allowing it to be browsed through a terminal accommodating a browser software.

According to a thirteenth aspect of the present invention, there is provided an image recording system comprising: an image recording unit which has a connecting function to the network and records an object as image data; and a server unit which provides information through the network, wherein when recording the picked-up image data, the image recording unit adds information obtained from the server unit through the network to the image data.

Preferably, for example, according to a fourteenth aspect of the invention, in the image recording system according to the thirteenth aspect, the image recording unit obtains information from the network based on a time interval set up preliminarily.

Preferably, for example, according to a fifteenth aspect of the invention, in the image recording system according to the fourteenth aspect, the time interval is capable of being set up for each information depending on the content of the information to be obtained.

According to a sixteenth aspect of the invention, there is provided an image recording system comprising: an image recording unit which records an image of the object as image data; and a network connecting device which accesses the server unit through the network so as to obtain information provided by the server unit and send the information to the image recording unit, wherein the image recording unit records information obtained through the network connecting device in relation with the picked-up image data.

Preferably, for example, according to a seventeenth aspect of the invention, in the image recording system according to the sixteenth aspect, the image recording unit records based on an obtaining date of the information through the network connecting device and a photographing date of the image data.

Preferably, for example, according to an eighteenth aspect of the invention, in the image recording system according to the sixteenth aspect, the image recording unit outputs the image data and information related to the image data in a form allowing to be printed out all at once.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing the configuration of a system according to a first embodiment of the present invention;

FIG. 2 is a block diagram showing the configuration of a digital still camera according to the first embodiment;

FIG. 3 is a conceptual diagram for explaining a frame outputted from a CCD;

FIG. 4 is a conceptual diagram for explaining color processing;

FIG. 5 is a conceptual diagram for explaining color processing;

FIG. 6 is a conceptual diagram for explaining preprocessing of JPEG processing and DCT transformation;

FIG. 7 is a conceptual diagram showing a storage state of various kinds of data in a JPEG image format;

FIG. 8 is a conceptual diagram showing information downloaded from the Internet;

FIG. 9 is a flowchart showing processing for downloading information from Internet;

FIG. 10 is a flowchart of production processing for a picked-up image information HTML file;

FIG. 11 is a conceptual diagram showing an example of personal information which is added to the aforementioned information downloaded from the Internet;

FIG. 12 is a conceptual diagram showing interest item numbers of the personal information and objects corresponding to that number;

FIG. 13 is a block diagram showing the configuration of a system according to a second embodiment of the present invention;

FIG. 14 is a block diagram showing the configuration of a digital still camera 103;

FIG. 15 is a block diagram showing the functional configuration of Web server 100, Web servers 100-1 and 100-2;

FIG. 16 is a block diagram showing the functional configuration of a cradle 108;

FIG. 17 is a block diagram showing the basic configuration of a cellular phone 104 and a personal computer 107;

FIG. 18 is a conceptual diagram showing the configuration of a specified site list stored in the digital still camera 103;

FIG. 19 is a conceptual diagram showing a relation table which holds the relation between the specified site and a data file downloaded from that specified site;

FIG. 20 is a conceptual diagram showing a relation table which holds the relation between image data taken by and recorded in the digital still camera 103 and a data file downloaded from the specified site;

FIG. 21 is a conceptual diagram showing a relation table showing the relation between special sites for image attachment and a genre of data files prepared in those sites;

FIG. 22 is a conceptual diagram showing an example of information prepared in the special sites;

FIG. 23 is a schematic diagram showing an example of print out of a data file obtained from Web site 100-2 (special for image attachment) related to the picked-up image;

FIG. 24 is a flowchart for explaining a processing (downloading) for obtaining data from each Web server according to the second embodiment;

FIG. 25 is a flowchart for explaining a processing which relates (adds) data obtained from the Web server to an image picked-up with the digital still camera; and

FIG. 26 is a block diagram showing an example of modification of the second embodiment.

### DETAILED DESCRIPTION OF THE INVENTION

An embodiment of an image pickup device, image recording method, and image recording system according to the present invention will now be described with reference to the accompanying drawings.

Hereinafter, the preferred embodiments of the present invention will be described as an example in which a digital still camera is applied.

1. First Embodiment

1-1. Configuration of the First Embodiment

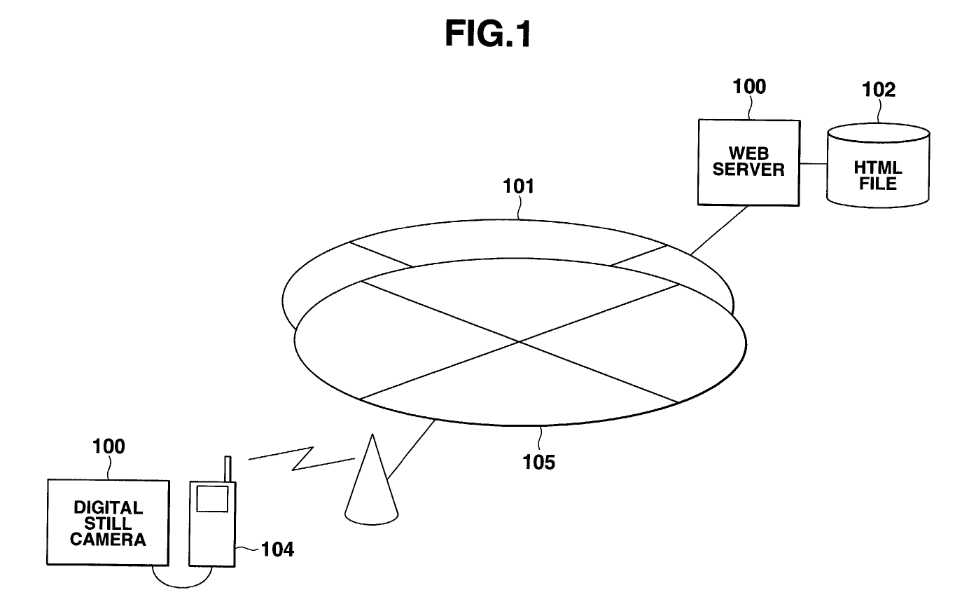

FIG. 1 is a block diagram showing the configuration of a system according to the first embodiment of the present invention. A Web server 100 is connected to Internet 101 so as to provide various kinds of terminals connected through the Internet 101 with an HTML file 102. Although FIG. 1 indicates only one Web server 100, actually it is possible to provide a plurality of the Web servers providing to various kinds of terminals with an HTML file.

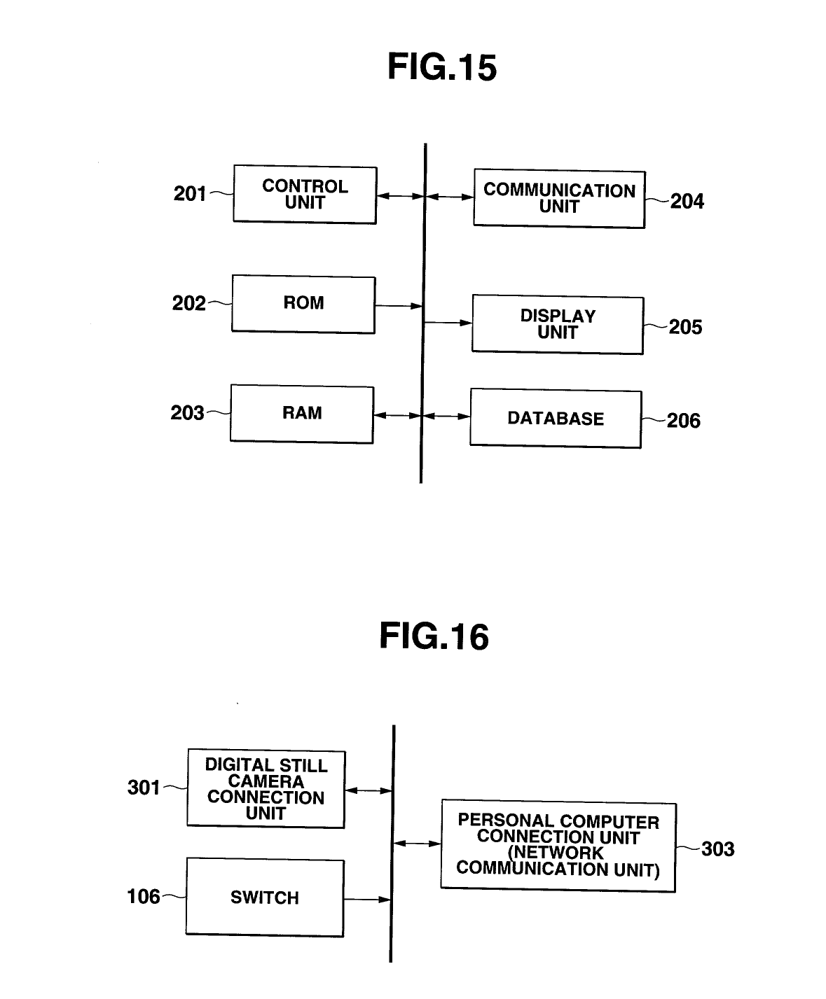

FIG. 15 is a block diagram showing the functional configuration of the Web server 100, a Web server 100-1 and a Web server 100-2, which will be described later. A control unit 201 reads out a program stored in a ROM 202 so as to control the entire Web server 100, 101-1, or 101-2. A RAM 203 is used as a working region for recording data temporarily or reading out. A communicating unit 204 connects to the Internet 101. A display unit 205 displays menu, data and the like. A database 206 stores various kinds of information publicized on network as a site. An HTML file 102 is produced from information stored in the database 206.

A digital still camera 103 (FIG. 1) picks up an object and stores image data in a recording medium. The digital still camera 103 connects a cellular phone 104 having communication function to the Internet 101 through a telephone network 105 and obtains the HTML file 102 provided by the Web server 100.

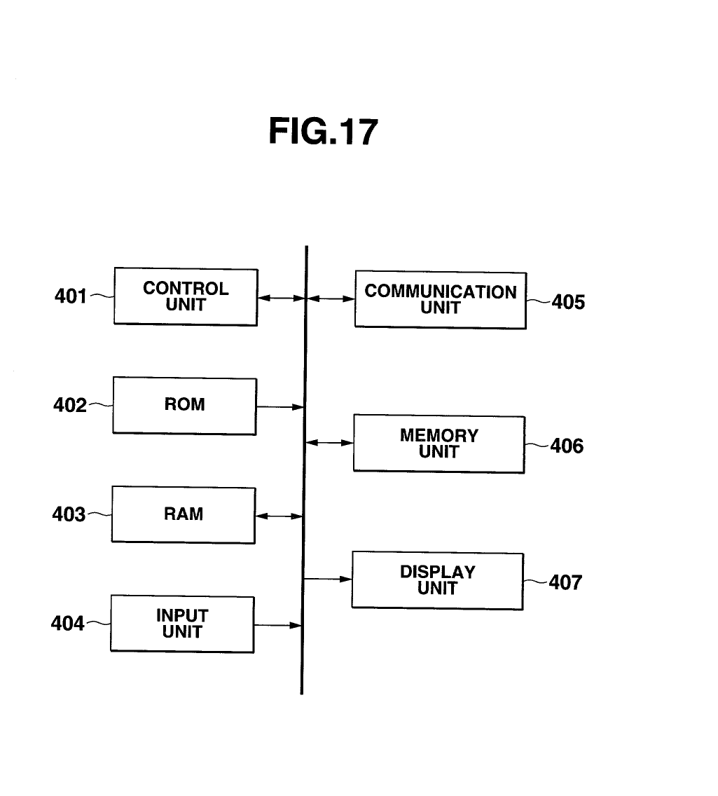

FIG. 17 is a block diagram showing the basic configuration of the cellular phone 104 and a personal computer 107, which will be described later. A control unit 401 controls its entire system according to a program read out from a ROM 402. A RAM 403 is used as a working memory which stores data temporarily. An input unit 404 comprises keys, buttons and the like, through which user inputs data. A communication unit 405 is connected to the Internet 101 through the telephone network 105 so as to communicate with the Web server 100. A storage unit 406 comprises a hard disc drive, nonvolatile memory or the like so as to store programs and data. A display unit 407 comprises a liquid crystal display unit and the like so as to display various kinds of data.

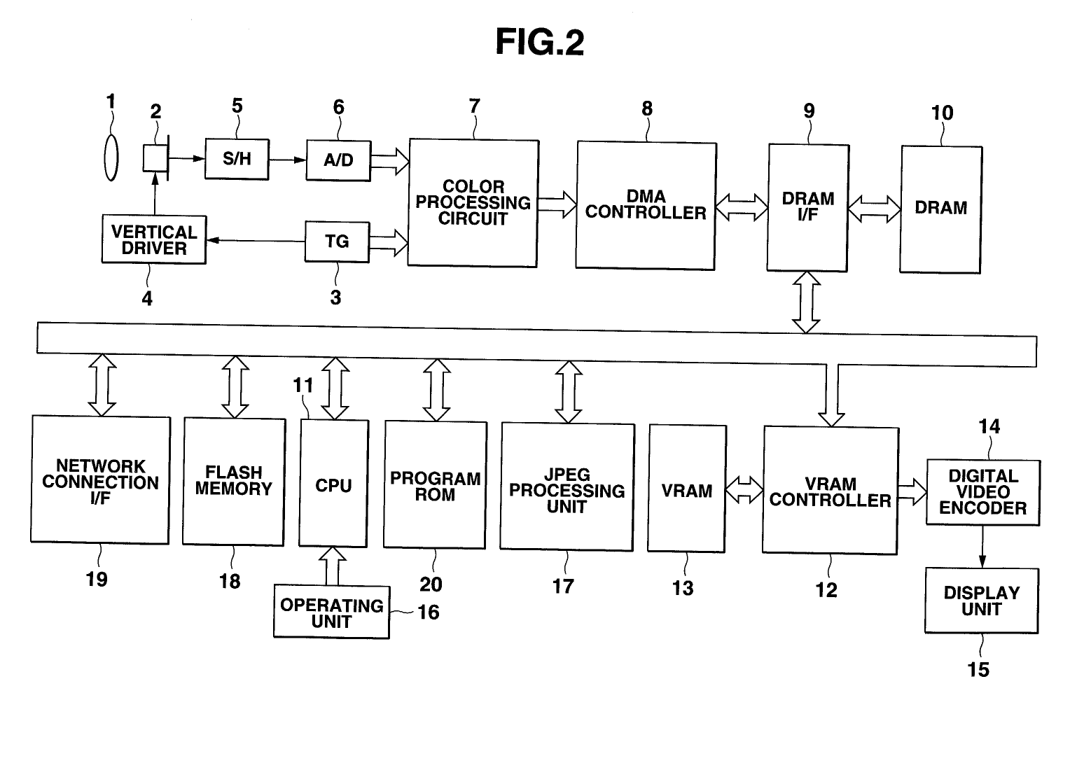

FIG. 2 is a block diagram showing the configuration of the digital still camera 103 according to the first embodiment. A lens 1 denotes a so-called objective lens, which photographs an object optically and focuses its image on a CCD 2. The CCD 2 is a device with configuration of metal-oxide semiconductor (MOS) for transferring electric charges in the form of an array and is driven by a timing generator (TG) 3 and a vertical driver 4 so as to output a result of photoelectric conversion corresponding to a single screen at every predetermined cycle. The timing generator 3 and the vertical driver 4 generate a timing signal necessary for reading out from the CCD 2. A sample-and-hold circuit (S/H) 5 samples time-series analog signals read out from the CCD 2 at a frequency fitting to a resolution of the CCD 2. An A/D converter 6 converts the sampled signal to a digital signal (bayer data).

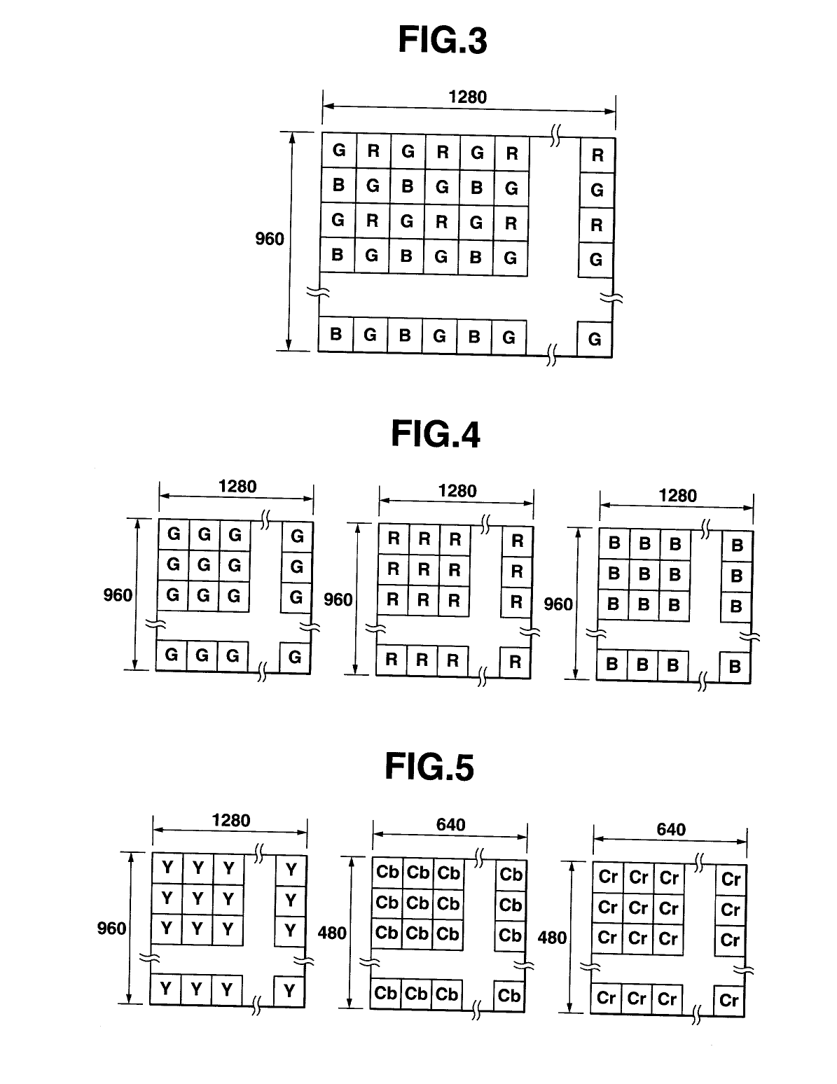

A color process circuit 7 carries out color processing for generating a luminance/color difference multiplex signal (hereinafter referred to as YUV signal) from the output of the A/D converter 6. In the color processing, the aforementioned bayer data is converted to R, G, B data as shown in FIG. 4 and further converted to the digital luminance/color difference multiplex signal (Y, Cb and Cr data) as shown in FIG. 5. According to the first embodiment, as shown in FIG. 3, the number of pixels of a frame outputted from the CCD 2 is 1280×960 pixels. As shown in FIG. 5, the number of pixels of the digital luminance/color difference multiplex signal is 1280×960 pixels for the Y data and 640×480 pixels for the Cb and Cr data. The Cb and Cr data are data obtained by averaging two pixels of the Y data vertically and laterally so that they are constituted by 4:1:1 data.

A DMA controller 8 executes data transmission between the color process circuit 7 and a DRAM 10 (accurately speaking, a DRAM interface 9) not through a CPU 11, that is, it does a direct memory access (DMA). The DMA controller 8 writes the Y, Cb and Cr data output of the color process circuit 7 into a buffer (not shown) in the DMA controller 8 using the synchronous signal of the color process circuit 7, a memory write enable signal and clock outputs, and executes DMA transfer through the DRAM interface (DRAM I/F) 9. The DRAM interface 9 provides signal interface between the DRAM 10 and the DMA controller 8 and signal interface between the DRAM 10 and a bus. The DRAM 10 stores image data (Y, Cb and Cr data) which is DMA-transferred from the DMA controller 8 through the DRAM interface 9.

The CPU 11 concentratedly controls the operation of the camera by executing a predetermined program stored in a program ROM 20 and is connected to an operating unit 16 including a main switch, a recording/reproduction mode changeover switch, a function selection key, a shutter key and the like. The program for the mode in the recording mode, or the program for the mode in the reproduction mode is loaded from the program ROM 20 to a RAM (not shown) in the CPU 11 and executed. After the aforementioned image data (Y, Cb and Cr data) is DMA-transferred to the DRAM 10, the CPU 11 reads out that image data (Y, Cb and Cr data) from the DRAM 10 through the DRAM interface 9 and writes it into a video RAM (VRAM) 13 through a VRAM controller 12.

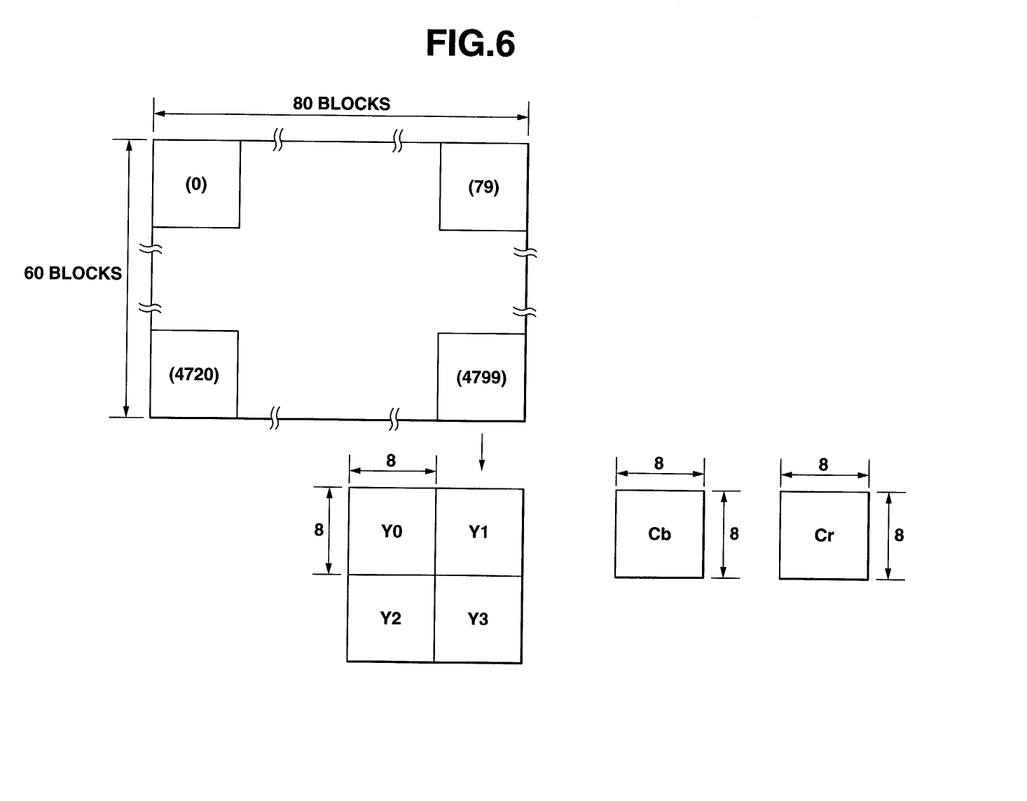

In the storage state with the aforementioned shutter key pressed, the CPU 11 reads out each MCU block composed of 16×16 pixels, which is obtained by dividing a frame into 80×60 blocks (0 to 4799) as shown in FIG. 6A successively, in each component of Y, Cb and Cr MCU unit stored in the DRAM 10 through the DRAM interface 9 and inserts an MCU block of image to be added and then sends to a JPEG processing unit 17. The image data received by the JPEG processing unit 17 is compressed through DCT conversion, quantization and encoding. The CPU 11 adds header information to the compressed image data and writes it into a flash memory 18 which is a nonvolatile memory. The header information comprises information about images and an The HTML file obtained from the Web server 100 on the Internet 101. The HTML file includes information about events which occur in the world at an image pick-up time, such as the weather information, news and the information about popular songs.

In the DCT conversion, as shown in FIG. 6B, with luminance component data composed of four 8×8 pixel blocks of Y0 to Y3 and color difference component data Cb and Cr each composed of 8×8 pixels as a group, each MCU block data is converted to 64 DCT coefficients, which is the same number as respective pixels indicating the amplitude of the frequency component. When compression processing of Y, Cb and Cr data corresponding to a frame and write processing of all the compressed data complete, the CPU 11 starts up a path to the DRAM 10 from the CCD 2.

The VRAM controller 12 controls data transmission between the VRAM 13 and path, and data transmission between the VRAM 13 and a digital video encoder 14, that is, controls writing of display image (preview image) into the VRAM 13 and reading-out of the same image from the VRAM 13.

The VRAM 13 is a so-called video RAM, in which when a preview image is written, that preview image is sent to a display unit 15 through the digital video encoder 14 and displayed on the display unit 15. There is a video RAM comprising two ports for writing and reading-out and carrying out writing and reading-out processes of the image in parallel at the same time. This type of the video RAM may be used as the VRAM 13 of this embodiment.

The digital video encoder (hereinafter referred to as a video encoder) 14 reads out the aforementioned image data (Y, Cb and Cr data) cyclically from the VRAM 13 through the VRAM controller 12, generates a video signal based on that image data and outputs to the display unit 15. Consequently, a through image based on the image information supplied from the CCD 2 is displayed on the display unit 15 in recording mode. The display unit 15 is a small liquid crystal panel of about several inches mounted on a rear side of the camera main body, composed of for example, 279×220 pixels.

The JPEG processing unit 17 compresses and extends based on JPEG. A JPEG compression parameter is given by the CPU 11 each time of the compression processing. Although the JPEG processing unit 17 is preferred to be achieved by a special hardware from the viewpoint of processing speed, it may be achieved by the CPU 11 in terms of software.

The flash memory 18 is a programmable read only memory (PROM), capable of erasing all bits (or in the unit of block) electrically and rewriting. The flash memory 18 may be of fixed type which cannot be removed from the camera main body or may be of removable type such as card type and package type. Meanwhile, the flash memory 18 has to be initialized (formatted) in a predetermined format irrespective of incorporated type or removable type. The initialized flash memory 18 is capable of recording image of a number corresponding to its storage capacity.

According to the first embodiment, a network connecting interface (network connecting I/F) 19 is connected to the server 100 on the Internet 101 following a specified URL according to a packet communication protocol of the cellular phone 104 as required, so as to obtain the HTML file from the server 100. Although the cellular phone 104 is connected to the network connection interface 19 as shown in FIG. 1 so that it is connected to the Internet 101 through the cellular phone 104, the present invention is not limited to this arrangement. It is possible to employ a removable communication module or incorporate communication function of the cellular phone 104 in the digital still camera 103 itself.

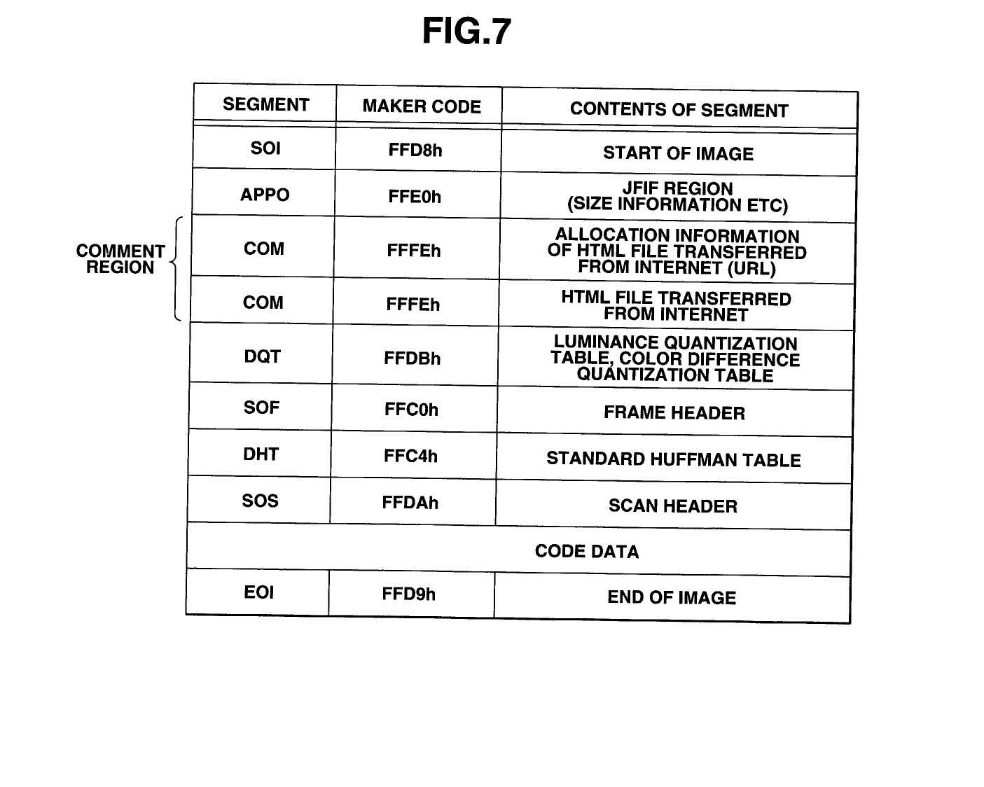

FIG. 7 is a conceptual diagram showing the storage state of various kinds of data in the JPEG image format. Allocation information (location information) and contents of the HTML file downloaded from the Internet 101 are stored in a comment region. The allocation information indicates a storage place (URL) about a plurality of the HTML files. The aforementioned HTML file includes information about events which occur in the world at an image pick-up time such as the weather information, news, the information of popular songs.

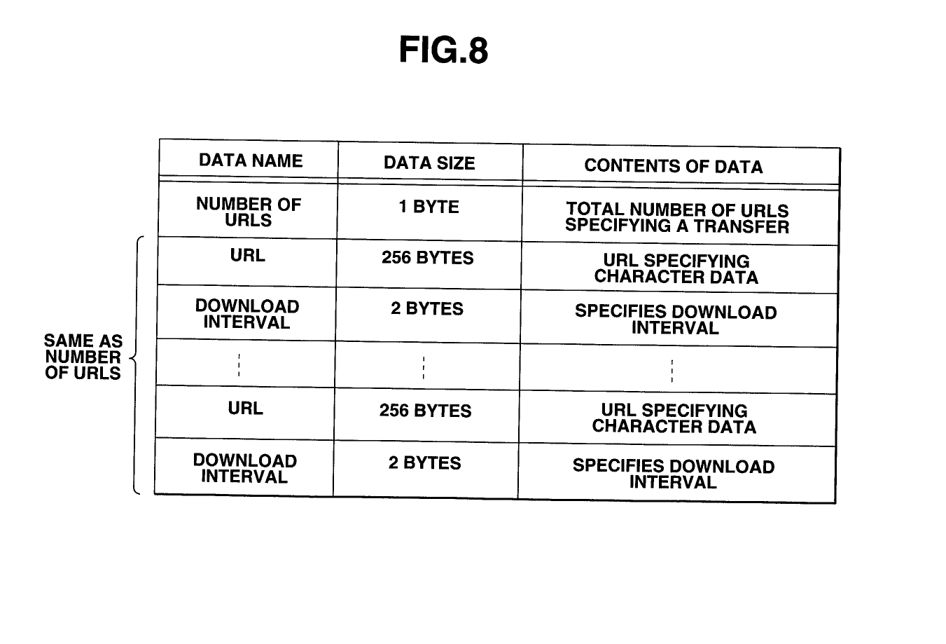

Next, FIG. 8 is a conceptual diagram showing information downloaded from the Internet. The information downloaded from the Internet is set up preliminarily by user. The information downloaded from the Internet 101 comprises the number of URLs indicating a location of the HTML file to be downloaded, each URL and download time interval. That is, a plurality of the URLs of the HTML file to be downloaded can be set up and the download time interval of each can be set up. The reason why there is a download time interval for respective URLs is that appropriate frequency of information desired to be updated is different, for example, every two hours for the weather information, every hour for news, every week for the information of popular songs. As described above, the CPU 11 obtains the HTML file 102 on the Internet 101 based on the information downloaded from the Internet 101 and adds it to image data as part of the comment region of the header information.

1-2. Operation of the First Embodiment

An operation of the digital still camera 103 according to the first embodiment will be described.

1-2-1. Information Download Processing

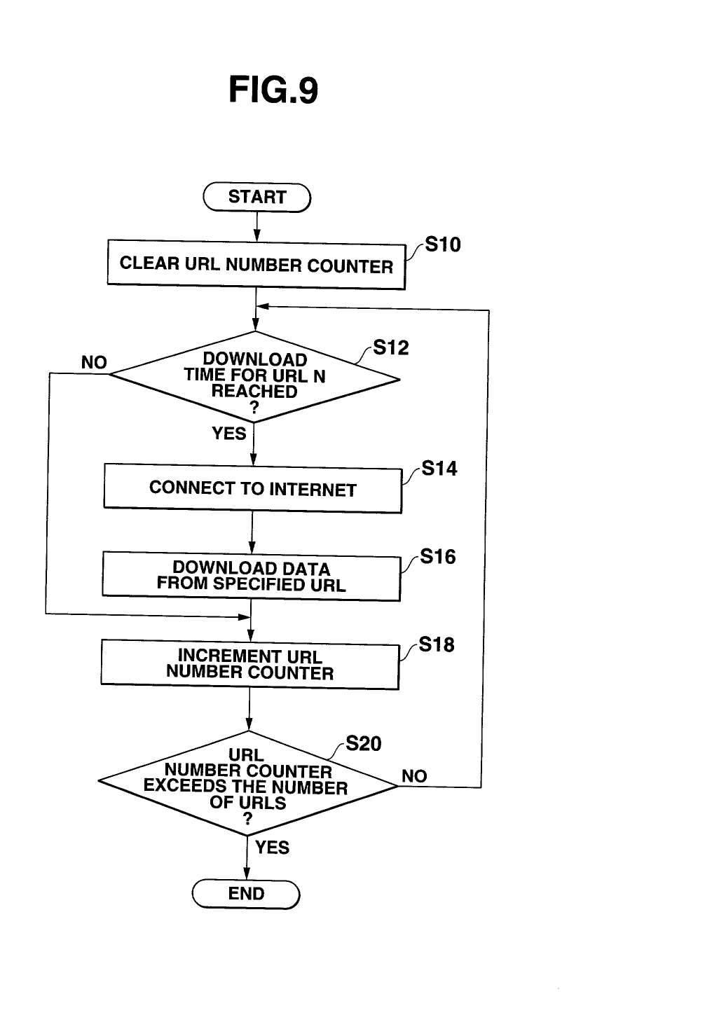

FIG. 9 is a flowchart showing processing for downloading information from the Internet 101. The processing shown in FIG. 9 is executed when power is turned on and every predetermined time through the network connection interface 19. If an image pick-up is started, that processing is interrupted temporarily and restarted after it ends.

A URL number counter is cleared (step S10). Next, it is determined whether or not read is to be started based on the download time interval of each URL specified by the internet downloaded information shown in FIG. 8 (step S12). When the download time is reached, the digital camera 103 is connected to the Internet 101 through the network connection interface 19 (step S14) and the HTML file is obtained from the URL specified by the internet download information shown in FIG. 8 (step S16).

The obtained HTML file is stored in the DRAM 10 temporarily. The stored HTML file is written into the comment region of the JPEG file as shown in FIG. 7 when an image is picked-up and stored in the flash memory 18 as a JPEG file. The URL number counter is incremented (step S18) and it is determined whether or not the URL number counter exceeds the number of URLs (step S20). If the URL number counter does not exceed the number of URLs, the processing returns to step S12, in which the processing is continued. On the other hand, when it exceeds the number of URLs, the processing ends.

As described above, according to the first embodiment, the HTML file located at a place specified by the URL is downloaded at the download time interval of each URL and stored successively in the DRAM 10. When an image is picked-up and stored in the flash memory 18 as the JPEG file, the aforementioned HTML file is written into the comment region of the JPEG file so that additional information is added to the image data.

1-2-2. Creation Processing of Picked-Up Image Information HTML File

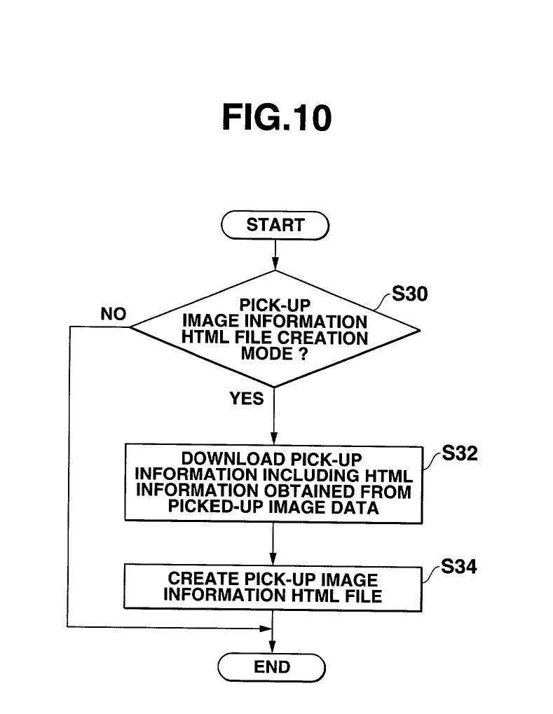

FIG. 10 is a flowchart showing creation processing of the picked-up image information HTML file. This processing is executed when the power is turned off. First, it is determined whether or not a picked-up image information HTML file creation mode flag is turned on (step S30). If the picked-up image information HTML file creation mode flag is off, that processing ends (“NO” in step S30). On the other hand, if the flag is turned on, an picked-up image information including the HTML file is downloaded successively from all image data (JPEG files) stored in the flash memory 18 (step S32). Other data than the HTML file includes data indicating shutter speed, focus mode, JPEG compression image quality, time data and the like. Next, the picked-up image information HTML file is created based on the downloaded HTML file, image data and image thumbnail data (step S34). The picked-up image information HTML file is stored in the flash memory 18.

The picked-up image information HTML file is transferred to the personal computer or the like externally connected to the flash memory 18 the network connection interface 19. By receiving the picked-up image information HTML file, the personal computer or the like allows browsing of the picked-up image, information about the picked-up image and additional information downloaded from the Internet 101 (that is, HTML file) using a browser software.

1-3. Modification of the Embodiment

It is possible to attach a link destination (URL) to an information source so that the information about personal information including user age, sex and interests made to be attached to the information downloaded from the Internet 103 can be displayed when the picked-up image information HTML file is browsed.

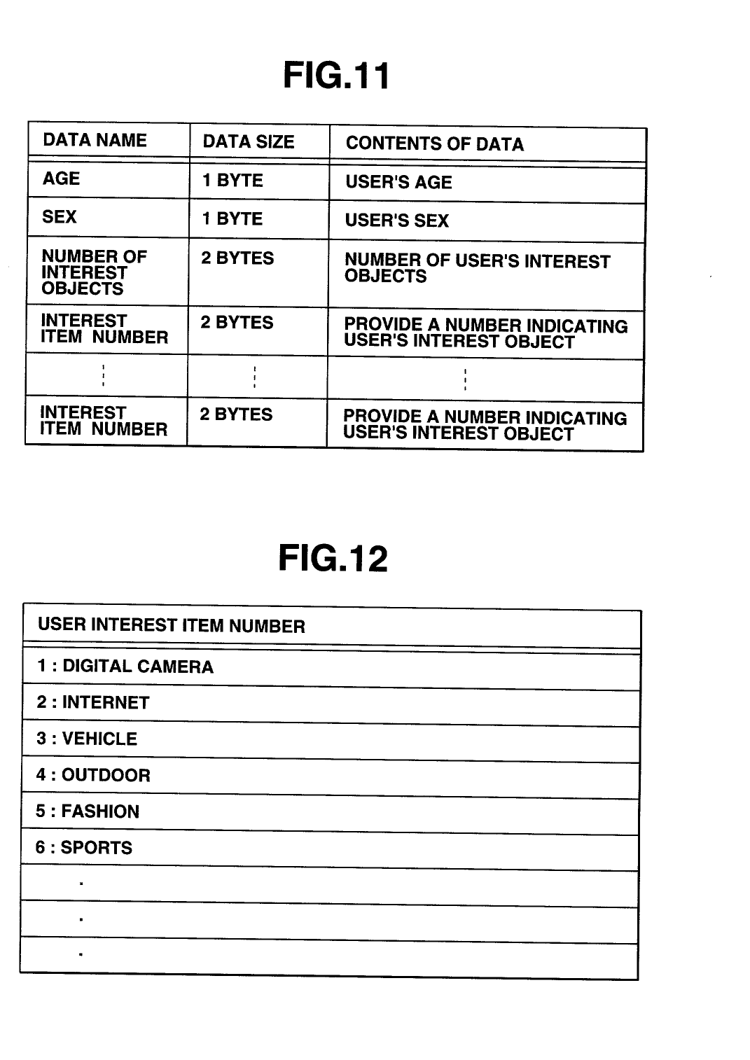

FIG. 11 is a conceptual diagram showing an example of personal information which is to be attached to the information downloaded from the Internet 103. In the indicated example, it is possible to specify age, sex, number of interest objectives and interest item number as personal information.

FIG. 12 is a conceptual diagram showing interest item number of the aforementioned personal information and an objective corresponding to that number. In the indicated example, the interest item number “1” corresponds to “digital camera”, “2” to “Internet”, “3” to “vehicle”, “4” to “outdoor”, “5” to “fashion”, “6” to “sports” and so on. User specifies his or her own interest objective according to the aforementioned interest item number.

When a browser terminal is connected to the Internet 101 while user browses the picked-up image information HTML file through a browsing terminal of the HTML file such as a personal computer, updated advertisement, information and the like desired by user can be displayed at a position of a URL attached as a link destination.

Because URL information specified by a user can be downloaded an image picked-up by the digital still camera 103, even when time passes after image pick-up is carried out, the weather information, news of a day of image pick-up, information about popular songs and the like can be downloaded from the picked-up image data and seen together with the picked-up image data, so that the user can look back to that day. Further, advertisement which may interest user about his age, sex and interest matters can be displayed in the HTML file and therefore, manufacturer can reduce the price of the digital still camera by gaining advertising revenue.

Although the downloaded HTML file is attached to image data of every image pick-up in the above embodiment, it is possible to store the HTML file as it is and make a link when a picked-up image information HTML file is created. Further, it is also possible to prepare various kinds of information about picking-up days over about last month in a home page of a manufacturer of the digital still camera and provide with a service from which information can be obtained later. Further, if the manufacturer of the digital still camera opens its original site including, for example, sport events and the like, for every genre, it is possible to access it to obtain information from this site and add it to image data.

Although the files to be downloaded from a specified URL are HTML files about the weather information, news, the popular songs information and the like in the above embodiment, the present invention is not limited to these matters and for example, other various kinds of files such as image file (still image, animation), audio file and the like may be downloaded as long as it is located at a specified URL. 2. Configuration of the second embodiment

2-1. Configuration of the Second Embodiment

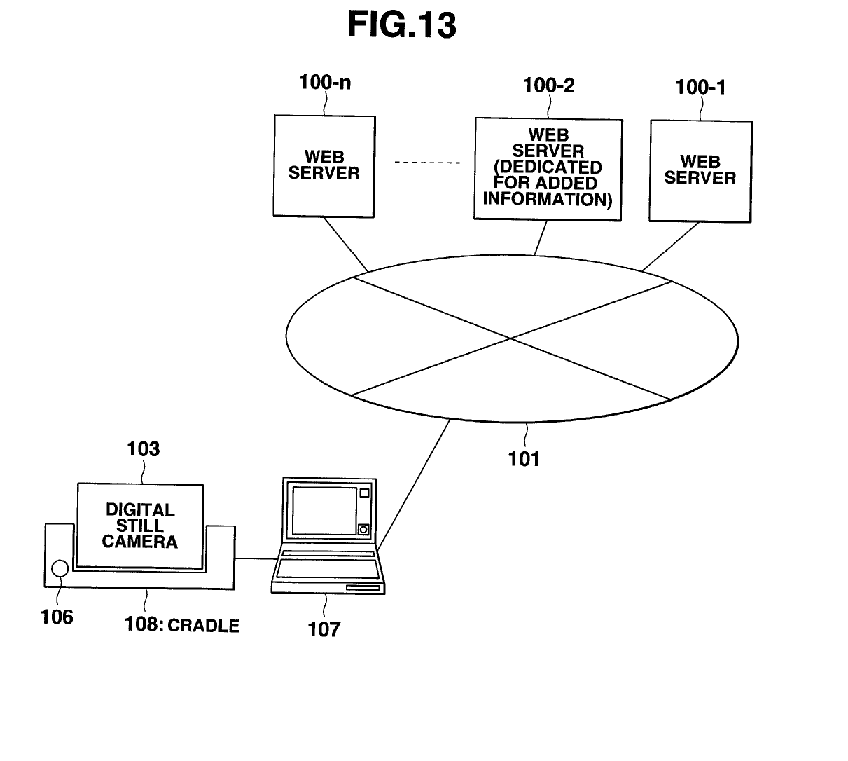

FIG. 13 is a block diagram showing the configuration of a system according to the second embodiment of the present invention. Web server 100-1, Web server 100-2, . . . Web server 100-n are connected to the Internet 101. The Web server 100-1 is an ordinary site which provides a Web page such that it can be browsed. The Web server 100-2 is a special site comprising information which is to be added to the image recorded in the digital still camera 103 and contains various kinds of genres of data easy to add to the image. If the digital still camera 103 is set up in a cradle 108, it is automatically (when the power of the digital still camera 103 is turned off, the switch 106 is pressed) connected to the Internet 101 through the personal computer 107 (started with power turned on).

By connecting the digital still camera 103 to a predetermined site (Web server), information is downloaded from that site so as to link a stored image with downloaded information and stored in the flash memory 18. If the information is downloaded on a day of image picking-up, information of that day can be attached to the image.

When information is downloaded from the ordinary site such as the Web server 100-1, the downloading capacity is limited by restricting data volume or downloading only a front page or a single image. Contrary to this, when information is downloaded from the special site such as the Web server 100-2, the information capacity does not have to be limited because that data volume has been appropriate to being attached to the digital still camera 103. The Web server 100-2, which is the special site, is managed by for example, the camera manufacturer.

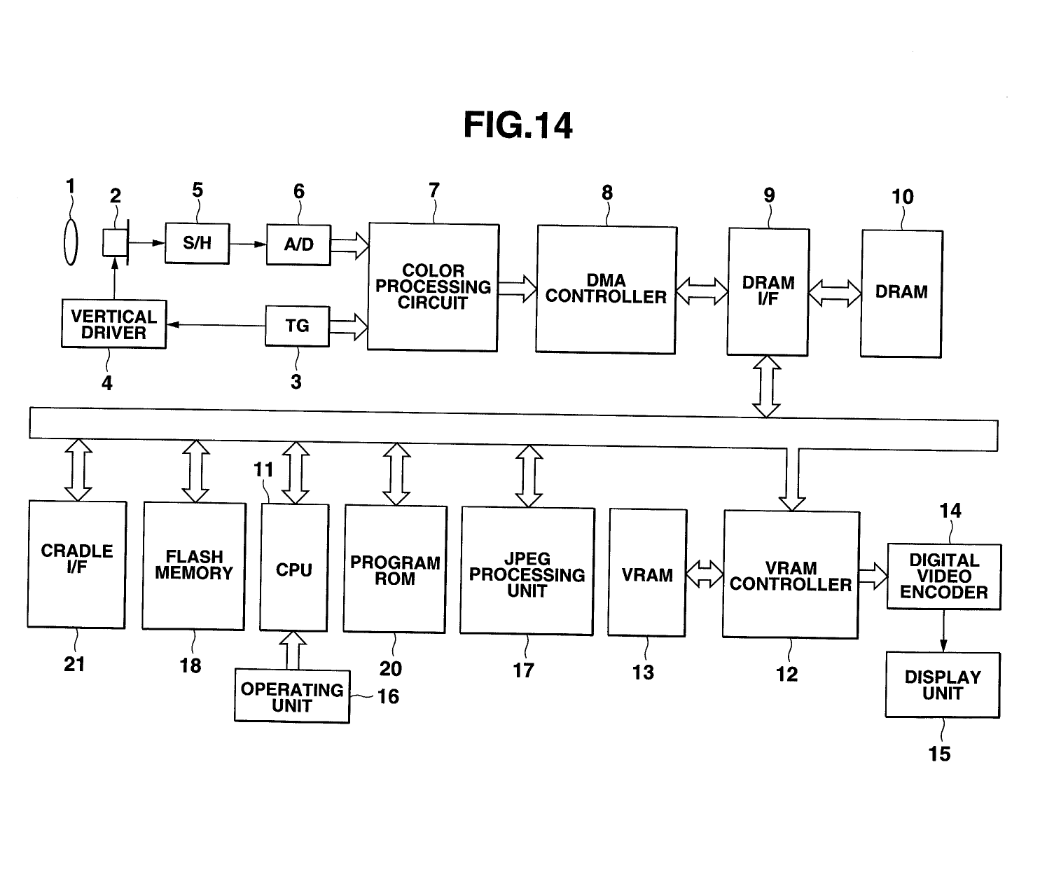

FIG. 14 is a block diagram showing the configuration of the digital still camera 103. Same reference numerals are attached to components corresponding to FIG. 2 and a description thereof is omitted. Because no data is downloaded at an image picking-up time, the JPEG does not need any COM as header information. A cradle I/F 21 is an interface for exchanging data with the cradle 108. The digital still camera 103 and the cradle 108 are connected to each other through a connector of the cradle I/F 21.

FIG. 15 is a block diagram showing the functional configuration of the Web servers 100, 100-1 and 100-2. Description of the contents described in the first embodiment is omitted. The database 206 stores various kinds of information publicized on the network as a site and the Web server 100-2 stores information of a size appropriate for being attached to the digital still camera 103 according to each genre.

FIG. 16 is a block diagram showing the functional configuration of the cradle 108. A digital still camera connection unit 301 achieves connection with the digital still camera 103. The switch 106 (in case of manual operation) urges a sequential operation from connecting to the Web site to download of information. A personal computer connection unit 303 achieves connection with the personal computer 107. The personal computer connection unit 303 may be provided with a modem or the like so as to be connected directly to the Internet 101 not through the personal computer 107 (not shown).

FIG. 17 is a block diagram showing the basic configuration of the cellular phone 104 and the personal computer 107. Description of the contents described about the cellular phone 104 of the first embodiment is omitted. The communication unit 405 communicates with the Web servers 100-1 to 100-n through the Internet 101. The storage unit 406 comprises a hard disc drive or the like in which a program and data are stored. The display unit 407 comprises a liquid crystal display so as to display various kinds of data.

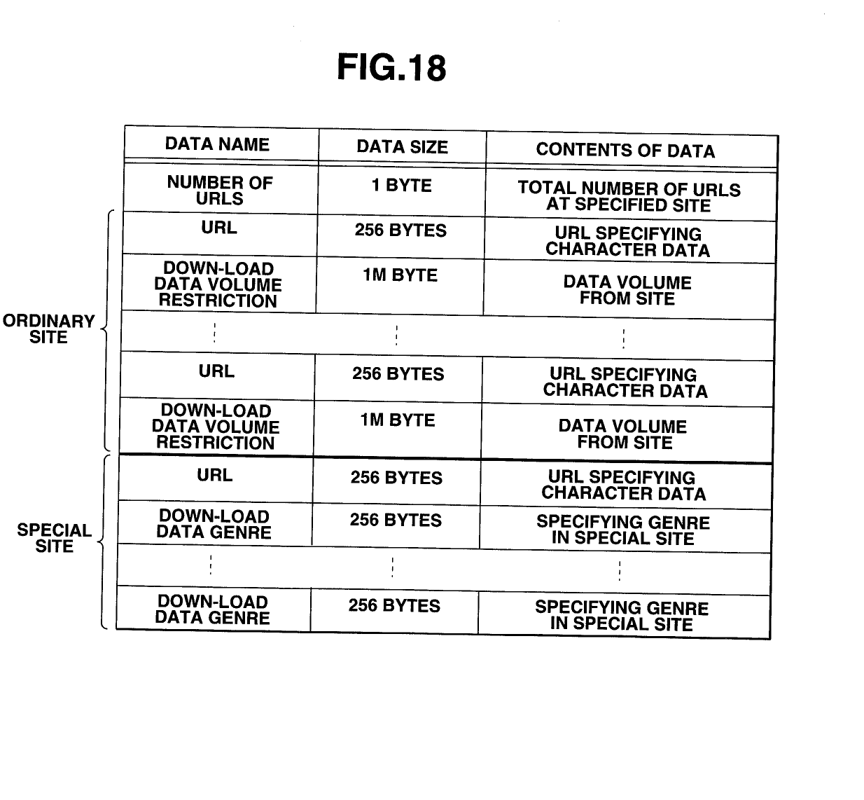

FIG. 18 is a conceptual diagram showing the configuration of a list of specified sites stored in the digital still camera 103. The specified site list stores the number of URLs as the number of connecting sites. Further, it stores URLs of destinations which are equivalent to the number of URLs and restriction of data volume to be downloaded. Further, in case of a special site, its URL and its specified genres are specified. This specified site list is registered beforehand in the digital still camera 103 by a user and stored in the flash memory 18.

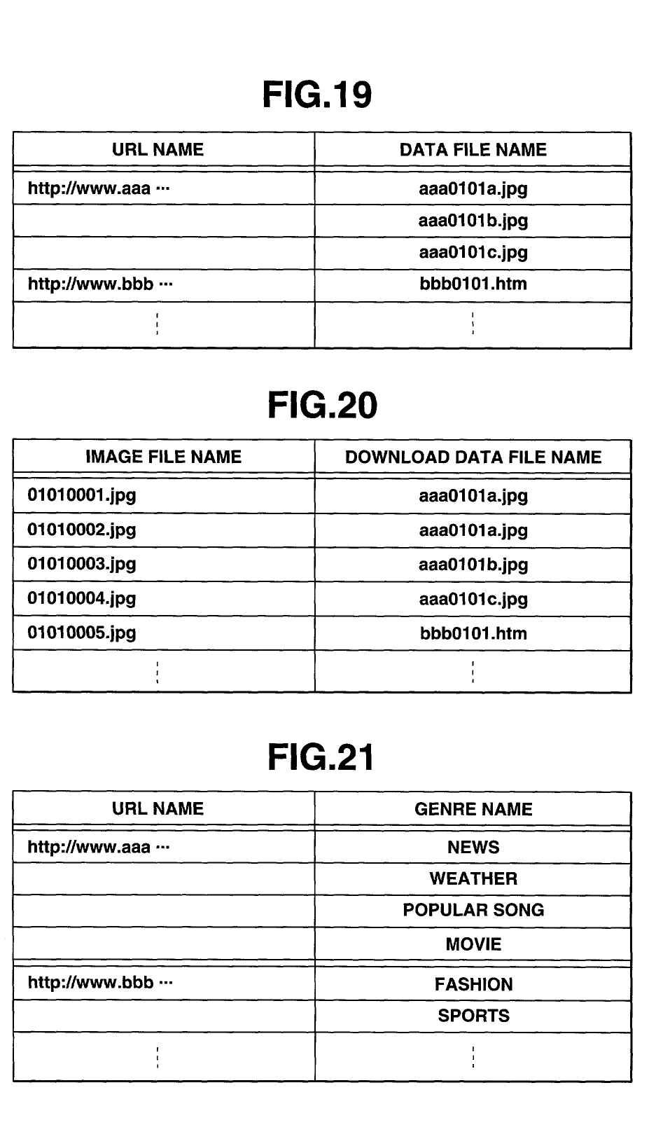

FIG. 19 is a conceptual diagram showing a relation table for storing the relation between a specified site and a data file downloaded from the specified site. The downloaded data file is an image file or an HTML file.

FIG. 20 is a conceptual diagram showing a relation table for storing the relation between image data picked-up by and recorded in the digital still camera 103 and a data file downloaded from the specified site. The relation between image data and data file is established basically according to date and for example, image data picked-up on the same day is related with the data file downloaded on the same day. As for data to be related to each image, the downloaded data file may be related at random. If the information is downloaded on an image picking-up day, the information of that day can be obtained and attached to a picked-up image. Of course, the downloaded data file can be related even if the picking-up day is passed. Although this relation table and downloaded data file are stored in the flash memory 18 in the digital still camera 103, they may be stored in the hard disc drive of the personal computer 107 and the like.

FIG. 21 is a conceptual diagram showing a relation table showing a relation between a special site (Web server 100-2) for attaching the image and a genre of data file prepared at that site. If for example, a genre “news” is specified, a news article is downloaded from the Web server of a URL (www.aaa . . . ) in which the genre “news” is registered. The file style is prepared in the form of image data and news is provided as simple comment type image data. The weather may be of image data such as a mark indicating fine day. Further, movie information, fashion information and the like are expressed in image data of a short sentence considering that they are to be attached to image data. Needless to say, it may be a short text data.

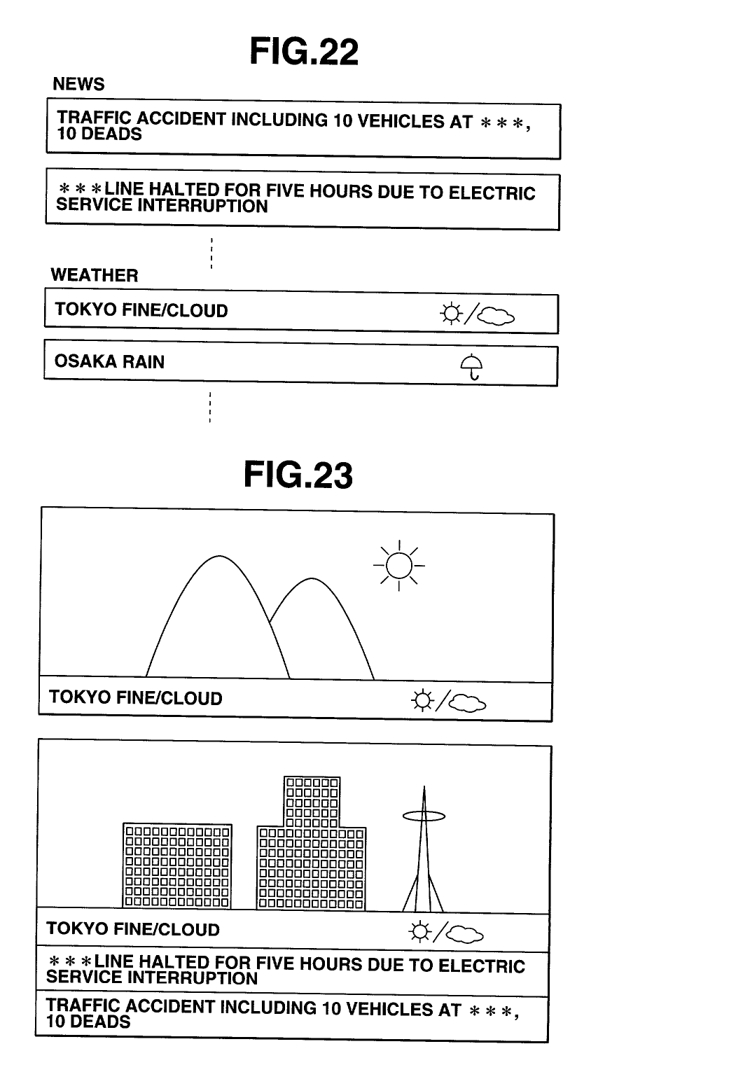

FIG. 22 is a conceptual diagram showing an example of information prepared in the special site. The file style is prepared in the form of image data of JPEG style. In the genre of weather, it is possible to specify even to a city such as Tokyo. Further, the news may be divided to narrower genres, like overseas and economic.

FIG. 23 is a schematic diagram showing an example of print out of a picked-up image related to the data file obtained from the Web site 100-2 (dedicated for image attachment). The print out style in this case includes printing the picked-up image with the related data file as well as printing the picked-up image and related data file separately. FIG. 23 shows an example in which the picked-up image and related data file are printed together. In this case, the data file obtained from the special Web site 100-2 may be JPEG style data, which is attached to the picked-up image and can be printed out as a single image.

2-2. Operation of the Second Embodiment

An operation of the second embodiment will be described.

2-2-1 Information Download Processing

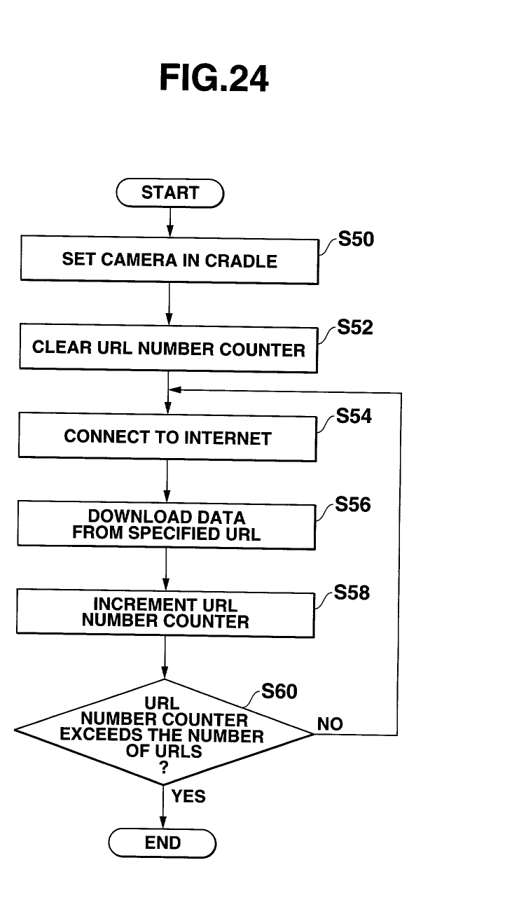

FIG. 24 is a flowchart for explaining a processing for downloading data from each Web server. After recognizing that the power of the personal computer 107 is turned on, the power of the digital still camera 103 is turned on and then, the camera 103 is set up in the cradle 108 (step S50). The URL number counter is cleared (step S52). The camera 103 is connected to the Internet 101 through the personal computer 107 (step S54).

Next, the camera 103 is connected to the Web server of a specified URL with reference to a table (FIG. 18) of a predetermined site so as to obtain data (step S56). At this time, data to be obtained from an ordinary Web server can be obtained up to a limited data amount, and for example, obtained in the form of a HTML style file. The URL number counter is incremented (step S58). It is determined whether or not the URL number counter value exceeds the number of URLs (step S60).

If the URL number counter value does not exceed the number of URLs, the processing is returned to step S54, in which the camera 103 is connected to a next URL with reference to a table of the specified site (FIG. 18) and the above-described processing is repeated. On the other hand, if the URL number counter value exceeds the number of URLs, that processing ends. Consequently, all the URLs registered in the table of a specified site (FIG. 18) are connected and the data file is downloaded from each Web server. Further, the data file of genre registered in the table of a specified site (FIG. 18) is downloaded from the special Web server 100-2.

2-2-2. Relating Processing

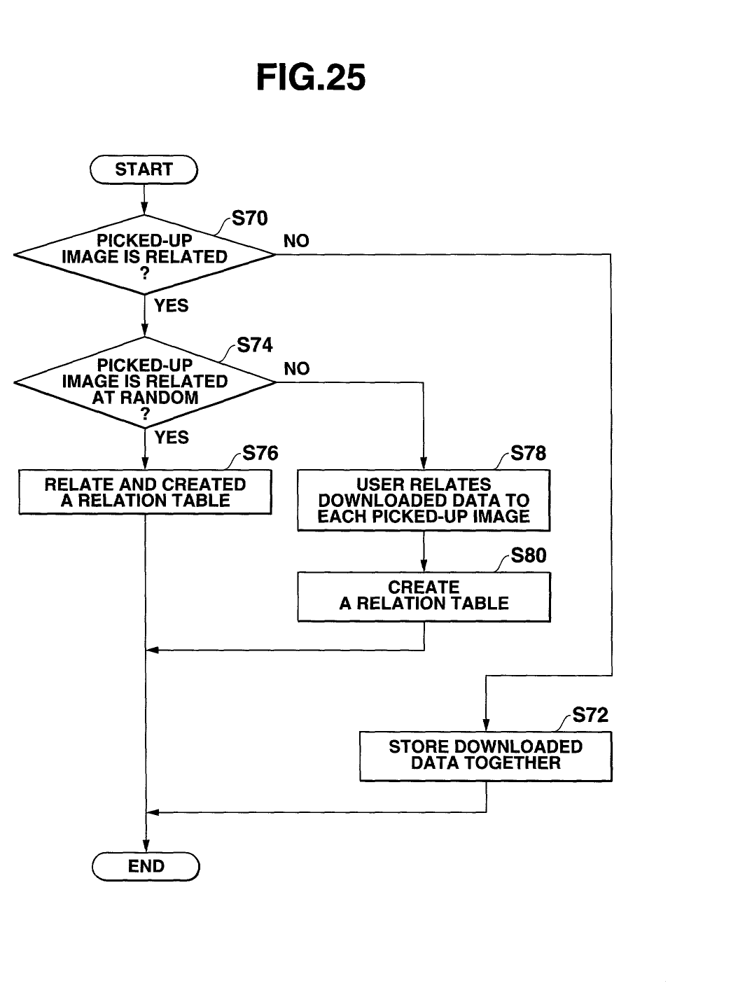

FIG. 25 is a flowchart for explaining a processing for relating (adding) data obtained from the Web server to image picked-up by the digital still camera 103. First, it is determined whether or not data obtained from the Web server 100-i (i=1 to n) should be related to the image (step S70). If the data is not related to the image, obtained data is gathered (to a single folder) and stored in the flash memory 18 of the digital still camera 103 and then, the processing ends (step S72).

On the other hand, if the data is to be related to the image, it is further determined whether or not data obtained from the Web server 100-i is to be related to the image at random (step S74). If the data obtained from the Web server 100-i is to be related to the image at random, the obtained data is added at random so as to create a relation table shown in FIG. 20 (step S76). The obtained data is gathered and stored in the flash memory 18 of the digital still camera 103 and then, the processing ends (step S72). If the number of the picked-up images is larger than the number of the obtained data files, the same data file is related to a different picked-up image (see “aaa0101a.jpg” shown in FIG. 20).

On the other hand, if the data obtained from the Web server 100-i is not to be related to the image at random, a user relates the obtained data file with the picked-up image manually (step S78) and creates a relation table shown in FIG. 20 (step S80). Then, the created relation table is stored in the flash memory 18 of the digital still camera 103 together with the obtained data and the processing ends.

The relation table shown in FIG. 19 is updated each time when processing which downloads data from each Web server is carried out as shown in FIG. 24. Further, an item of the relation table shown in FIG. 20 is added each time when the processing (FIG. 25) is executed. The same data file is never related to a single picked-up image. Tables shown in FIGS. 18 to 21 are stored unless user carries out resetting processing.

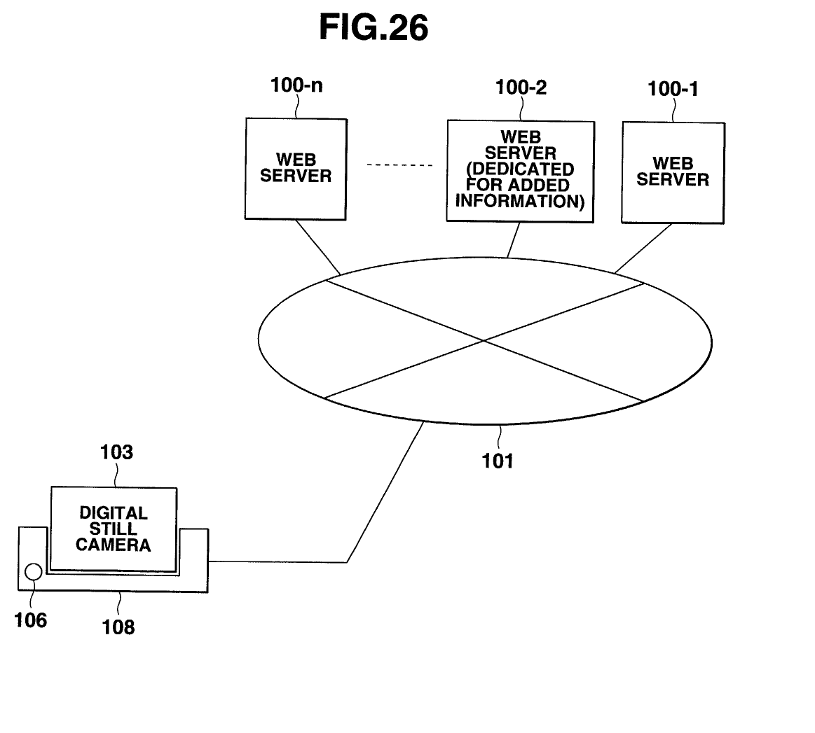

In the second embodiment, as shown in FIG. 26, it is possible to directly connect the cradle 108 with the Web server 100-i (i=i to n) through the Internet 101 not through the personal computer 107. In such case, the cradle 108 is directly connected to the Internet 101 by the personal computer connection unit 303 as shown in FIG. 16.

According to the second embodiment, only when the digital still camera 103 is set up in the cradle 108, a user can obtain information easily and relate it to a picked-up image. When information is obtained by connecting the camera 103 to the Web site on an image picking-up day, information about the picking-up day can be obtained so that this is referable when arranging the picked-up images in the future. Further, when obtaining information from the special site, it has therein provided a file arranged in information volume which allows it to be added to the picked-up image easily, the information is easy to add to the picked-up image and further, its printed result is easy to see. Thus, a different pleasure is given as compared to a case where just a picked-up image is printed out. Further, the digital still camera may be provided with communication function allowing to be connected directly to the Internet (by wire or radio). In this case, because it can be connected to the Internet not through the cradle or personal computer, it is possible to obtain information about the Web site anywhere and any time.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An image pickup device comprising:
an image pickup unit configured to pick up an image of an object;
an image storage unit configured to store the image which is picked up by the image pickup unit;
a connection unit connectable to the network;
an address storage unit configured to store an address on the network;
an information obtaining unit configured to obtain information on the network based on the address stored in the address storage unit; and
an adding unit configured to add the information obtained by the information obtaining unit to the image stored in the image storage unit.

2. An image pickup device according to claim 1, further comprising a setting unit configured to set a time interval at which the information obtaining unit obtains the information on the network based on the address stored in the address storage unit.

3. An image pickup device according to claim 1, wherein the address storage unit stores a plurality of addresses and the information obtaining unit obtains the information on the network based on the addresses stored in the address storage unit.

4. An image pickup device according to claim 1, further comprising a browser file creating unit configured to create a file having the image stored in the image storage unit and the information added to the image in a format which can be browsed by a terminal accommodating a browser software.

5. An image pickup device according to claim 2, further comprising a browser file creating unit configured to create a file having the image stored in the image storage unit and the information added to the image in a format which can be browsed by a terminal accommodating a browser software.

6. An image pickup device according to claim 3, further comprising a browser file creating unit configured to create a file having the image stored in the image storage unit and the information added to the image in a format which can be browsed by a terminal accommodating a browser software.

7. An image recording method comprising:
reading an address on a network which is stored in an image pickup device;
connecting the image pickup device to a site designated by the read address through the network;
obtaining information from the site through the network; and
adding the obtained information to a picked up image when the image pickup device stores the image.

8. An image recording method according to claim 7, wherein the obtaining comprising cyclically obtaining the information with a predetermined time interval.

9. An image recording method according to claim 8, wherein the predetermined time interval is determined for each information to be obtained based on a content of the information.

10. An image recording method according to claim 7, further comprising creating a file having the image and the added information in a format which can be browsed by a terminal accommodating a browser software.

11. An image recording method according to claim 8, further comprising creating a file having the image and the added information in a format which can be browsed by a terminal accommodating a browser software.

12. An image recording method according to claim 9, further comprising creating a file having the image and the added information in a format which can be browsed by a terminal accommodating a browser software.

13. An image recording system comprising:
an image recording unit connectable to a network and configured to record image data of an object; and
a server unit configured to provide information through the network,
wherein the image recording unit adds the information obtained from the server unit through the network to the image data when the image recording unit records the image data.

14. An image recording system according to claim 13, wherein the image recording unit cyclically obtains the information from the server unit with a predetermined time interval.

15. An image recording system according to claim 14, wherein the predetermined time interval is determined for each information to be obtained based on a content of the information.

16. An image recording system comprising:
an image recording unit configured to record image data of an object;
a server unit configured to provide information through the network; and
a network access unit connected to the image recording unit and configured to be connected to the server unit through the network, obtain the information from the server through the network, and transfer the obtained information to the image recording unit, wherein the image recording unit records the transferred information in association with recorded image data.

17. An image recording system according to claim 16, wherein the image recording unit records the transferred information in association with recorded image data based on an obtaining date of the transferred information and a pick-up date of the recorded image data.

18. An image recording system according to claim 17, wherein the image recording unit records such information in association with recorded image data that has the obtaining date same as the pick-up date of the recorded image data 19. An image recording system according to claim 16, wherein the image recording unit outputs the recorded image data and obtained information in a form allowing to be printed out all at once.
